(19) United States
(12) Patent Application Publication
(10) Pub. No.: US 2007/0216239 A1
(43) Pub. Date: Sep. 20, 2007

(54) Tray assembly for spindle motor with aerodynamic bearing

(75) Inventors: Alex Horng, Kaohsiung (TW); Kuo-Hsiang Chen, Kaohsiung (TW)

Correspondence Address: BIRCH STEWART KOLASCH & BIRCH, PO BOX 747, FALLS CHURCH, VA, 22040-0747, US

(73) Assignee: Sunonwealth Electric Machine Industry Co., Ltd.

(21) Appl. No.: 11/374,086

(22) Filed: Mar. 14, 2006

(51) Int. Cl. H02K 7/00; H02K 5/16; H02K 21/12

(52) U.S. Cl. 310/67 R; 310/156.06; 310/90; 310/68 B

(57) ABSTRACT

A tray assembly for a spindle motor includes a tray and an aerodynamic rotational shaft. The tray includes an engaging hole in a center thereof. The aerodynamic rotational shaft includes an outer circumference with a smooth surface. An end of the aerodynamic rotational shaft is engaged in the engaging hole of the tray, with the outer circumference of the end of the aerodynamic rotational shaft engaged with an inner circumference of the engaging hole of the tray by forcibly fitting, allowing precise control and adjustment of an engaging relationship between the aerodynamic rotational shaft and the tray.

### BACKGROUND OF THE INVENTION

1. Field of the Invention

The present invention relates to a tray assembly for a spindle motor. More particularly, the present invention relates to a tray assembly for a spindle motor with an aerodynamic bearing.

2. Description of Related Art

FIGS. 1 and 2 illustrate a conventional tray assembly for a spindle motor with an aerodynamic bearing. The tray assembly 1 is rotatably mounted on a fixed portion 2 and comprises a tray 11, a rotor housing 12, a permanent magnet 13, and an aerodynamic rotational sleeve 14. The tray 11 is substantially a disc and includes an engaging hole 110 in a center of an underside thereof for securely receiving an end of the aerodynamic rotational sleeve 14. The rotor housing 12 is substantially inverted bowl-like and mounted below the tray 11. The permanent magnet 13 is fixed to an inner circumference of the rotor housing 12. The aerodynamic rotational sleeve 14 includes an aerodynamic hole 140.

The fixed portion 2 comprises a substrate 21, an axle tube 22, a stator 23, and an aerodynamic fixed shaft 24. The substrate 21 has a central hole (not labeled) into which the axle tube 22 is fixed. The axle tube 22 includes a receiving hole 220 having a coupling section 221 at a bottom thereof. The stator 23 is mounted around the axle tube 22. An end of the aerodynamic fixed shaft 24 is received in the coupling section 221, with the other end of the aerodynamic fixed shaft 24 received in the aerodynamic hole 140 of the aerodynamic rotational sleeve 14.

Referring to FIG. 2, the inner circumference of the aerodynamic hole 140 of the aerodynamic rotational sleeve 14 and the outer circumference of the aerodynamic fixed shaft 24 are smooth surfaces made of ceramic material, with a relatively small gap (not labeled) existing between the aerodynamic rotational sleeve 14 and the aerodynamic fixed shaft 24. Hence, when an end of the aerodynamic fixed shaft 24 is inserted into the aerodynamic hole 140 of the aerodynamic rotational sleeve 14, the air in the aerodynamic hole 140 is squeezed inward by the aerodynamic fixed shaft 24 and could not escape via the gap, creating an aerodynamic pressure in the aerodynamic hole 140. Thus, when the coils of the stator 23 are energized to create an alternating magnetic field and the permanent magnet 13 senses the alternating magnetic field and thus drives the tray assembly 1 to turn at high speed, the air in the gap avoids rotational friction between the aerodynamic rotational sleeve 14 and the aerodynamic fixed shaft 24 and thus reduces the risk of generation of frictional heat.

The outer circumference of the end of the aerodynamic rotational sleeve 14 is coupled with an inner circumference of the engaging hole 110 of the tray 11. However, since the engaging area between the inner circumference of the engaging hole 110 of the tray 11 and the outer circumference of the aerodynamic rotational sleeve 14 is relatively large and since the aerodynamic rotational sleeve 14 is tubular, the structural strength of the aerodynamic rotational sleeve 14 is relatively low. Hence, when the aerodynamic rotational sleeve 14 is forcibly fitted into the engaging hole 110, the aerodynamic rotational sleeve 14 is apt to crack due to the large engaging area and the tubular structure of the aerodynamic rotational sleeve 14. Further, in a case that the aerodynamic rotational sleeve 14 is mounted in the engaging hole 110 by gluing, excessive or insufficient amount of glue or uneven gluing would lead to adverse affect to the balancing weight and to the yield of assembled products.

Furthermore, the above-mentioned assembling method could not allow further reduction of the size of the aerodynamic rotational sleeve 14 and of the overall size. Namely, minimization of the spindle motor is not possible. Further, even if the outer circumference of the aerodynamic rotational sleeve 14 and the engaging hole 110 can be assembled in a balanced manner, it is difficult to control the evenness of the inner circumference of the aerodynamic rotational sleeve 14 to be identical to that of the outer circumference of the aerodynamic rotational sleeve 14. Hence, coincidence of the actual rotational axis of the inner circumference of the aerodynamic rotational sleeve 14 and the actual rotational axis of the outer circumference of the aerodynamic rotational sleeve 14 could not be guaranteed.

Further, no balancing structure is provided between the tray assembly 1 and the fixed portion 2 except the aerodynamic rotational sleeve 14 and the aerodynamic fixed shaft 24. In a case that air in the gap leaks, the operational effect of the aerodynamic rotational sleeve 14 and the aerodynamic fixed shaft 24 is adversely affected to a large extent.

### OBJECTS OF THE INVENTION

An object of the present invention is to provide a tray assembly for a spindle motor with an aerodynamic bearing, wherein the yield of assembled products is increased.

Another object of the present invention is to provide a tray assembly for a spindle motor with an aerodynamic bearing, wherein the balance adjustment of the tray assembly is more flexible.

A further object of the present invention is to provide a tray assembly for a spindle motor with an aerodynamic bearing, wherein the rotational balance of the tray assembly is improved.

Still another object of the present invention is to provide a tray assembly for a spindle motor with an aerodynamic bearing, wherein minimization of the motor is allowed.

### SUMMARY OF THE INVENTION

A tray assembly for a spindle motor in accordance with the present invention comprises a tray and an aerodynamic rotational shaft. The tray includes an engaging hole in a center thereof. The aerodynamic rotational shaft comprises an outer circumference with a smooth surface. The aerodynamic rotational shaft comprises an end engaged in the engaging hole of the tray, with the outer circumference of the end of the aerodynamic rotational shaft engaged with an inner circumference of the engaging hole of the tray by forcibly fitting, allowing precise control and adjustment of an engaging relationship between the aerodynamic rotational shaft and the tray.

Preferably, the engaging hole of the tray is a through-hole to allow easy adjustment of the engaging relationship between the aerodynamic rotational shaft and the tray.

Preferably, the tray further comprises a flange on an upper side thereof, with the engaging hole of the tray extending through the flange for increasing an engaging area of the inner circumference of the engaging hole.

Preferably, the tray further comprises a coupling flange on an underside thereof. A rotor housing is coupled with the coupling flange and a permanent magnet is mounted to an inner circumference of the rotor housing.

Preferably, the tray assembly further comprises a fixed portion that includes an aerodynamic fixed sleeve having an aerodynamic hole for rotatably receiving another end of the aerodynamic rotational shaft, with a gap existing between the aerodynamic rotational shaft and the aerodynamic fixed sleeve.

Preferably, the fixed portion further comprises a substrate, an axle tube supported by the substrate, and a stator mounted around the axle tube. The aerodynamic fixed sleeve is mounted in the axle tube.

Preferably, the aerodynamic hole of the aerodynamic fixed sleeve comprises an inner circumference having a smooth surface made of ceramic material.

Preferably, the aerodynamic hole is a blind hole or a through-hole.

Preferably, the axle tube comprises an end wall. A ball is mounted between the end wall of the axle tube and an end face of the aerodynamic rotational shaft.

Preferably, the end face of the aerodynamic rotational shaft comprises a recess, and the ball abuts against a wall delimiting the recess.

Preferably, the ball is received in the recess and slightly protrudes beyond the recess, allowing joint rotation of the ball and the aerodynamic rotational shaft.

Preferably, a padding member is mounted to the end wall of the axle tube for rotatably supporting the ball.

Preferably, the tray further comprises a first balancing plate and the fixed portion comprises a second balancing plate. The first balancing plate and the second balancing plate attract each other to assist in maintaining rotational balance of the tray assembly.

Preferably, the first balancing plate is one of a magnetic balancing plate and a magnetically conductive balancing plate, and the second balancing plate is the other of the magnetic balancing plate and the magnetically conductive balancing plate.

Preferably, the first balancing plate and the second balancing plate are magnetic balancing plates having opposed poles on opposed faces respectively of the magnetic balancing plates.

Preferably, the tray further comprises an engaging portion on an underside thereof for engaging with the first balancing plate.

Preferably, the axle tube of the fixed portion comprises a shoulder on a top thereof for engaging with the second balancing plate.

Other objects, advantages and novel features of this invention will become more apparent from the following detailed description when taken in conjunction with the accompanying drawings.

### BRIEF DESCRIPTION OF THE DRAWINGS

FIG. 1 is an exploded perspective view, partly cutaway, of a conventional tray assembly for a spindle motor with an aerodynamic bearing;

FIG. 2 is a sectional view of the tray assembly in FIG. 1;

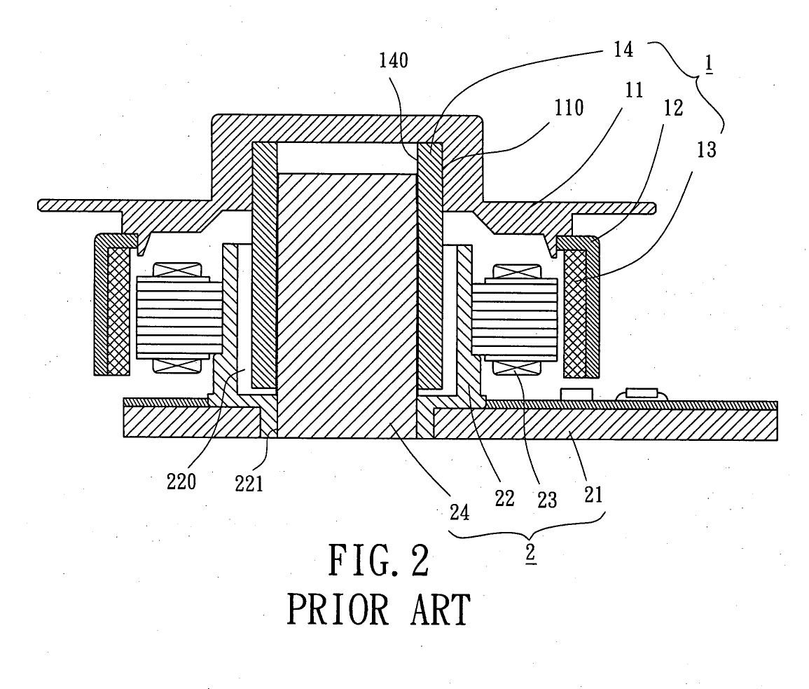

FIG. 3 is an exploded perspective view, partly cutaway, of a first embodiment of a tray assembly for a spindle motor with an aerodynamic bearing in accordance with the present invention;

FIG. 4 is a sectional view of the tray assembly in FIG. 3;

FIG. 5 is an exploded perspective view, partly cutaway, of a second embodiment of the tray assembly in accordance with the present invention; and

FIG. 6 is a sectional view of the tray assembly in FIG. 5.

### DETAILED DESCRIPTION OF THE PREFERRED EMBODIMENTS

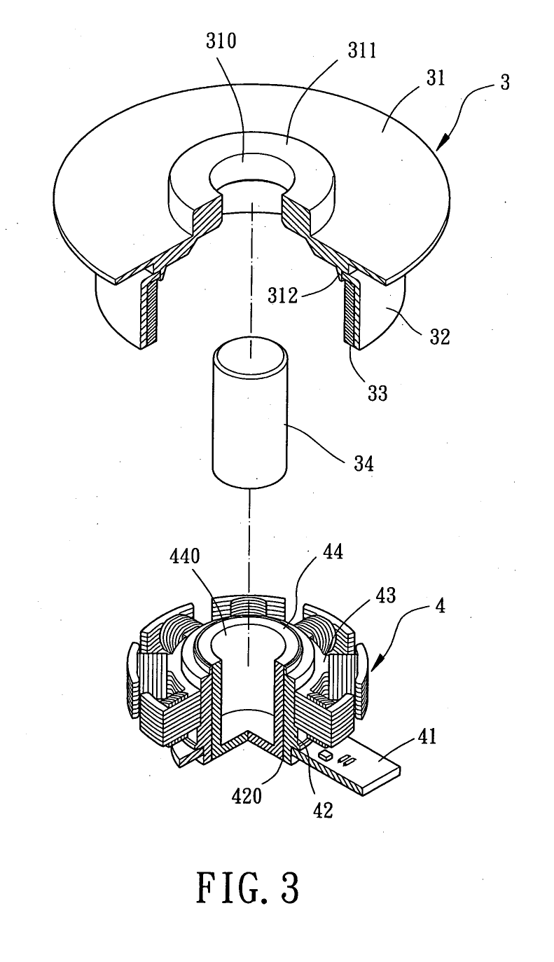

Referring to FIG. 3, a first embodiment of a tray assembly 3 in accordance with the present invention is rotatably mounted on a fixed portion 4. An object (not shown) such as an optical disk, a magnetic disk, or a floppy disk can be mounted on a tray 31 of the tray assembly 3. The fixed portion 4 is fixed inside an optical disc drive (not shown), a magnetic disk drive (not shown), or a floppy disc drive (not shown). The fixed portion 4 supports and drives the tray. 31 to turn.

The tray assembly 3 comprises the tray 31, a rotor housing 32, a permanent magnet 33, and an aerodynamic rotational shaft 34. The tray 31 is substantially a disc and includes an engaging hole 310 in a center of an underside thereof. A flange 311 is formed on an upper side of the tray 31, with the engaging hole 310 extending through the flange 311. An engaging area of an inner circumference of the engaging hole 310 is thus increased. A coupling flange 312 is formed on an underside of the tray 31. The rotor housing 32 is substantially inverted bowl-like and comprises an opening (not labeled) for coupling with the coupling flange 312 of the tray 31.

The permanent magnet 33 is fixed to an inner circumference of the rotor housing 32. The aerodynamic rotational shaft 34 is substantially cylindrical and preferably made of ceramic material. Alternatively, the aerodynamic rotational shaft 34 includes an outer circumference that has a smooth surface made of ceramic material. An end of the aerodynamic rotational shaft 34 is forcibly fitted in the engaging hole 310 of the tray 31, with the other end of the aerodynamic rotational shaft 34 coupled with the fixed portion 4.

Still referring to FIG. 3, the fixed portion 4 comprises a substrate 41, an axle tube 42, a stator 43, and an aerodynamic fixed sleeve 44. The substrate 41 has a central hole (not labeled) into which the axle tube 42 is fixed. A plurality of electric elements (not labeled) or a circuit board (not labeled) are mounted on the substrate 41. The axle tube 42 includes a receiving hole 420 that is preferably a through-hole. The stator 43 is mounted around the axle tube 42 and comprises at least one iron core (not labeled) and at least one coil (not labeled). The aerodynamic fixed sleeve 44 is substantially tubular and includes an aerodynamic hole 440 that is preferably a blind hole for containing gas such as air. The aerodynamic fixed sleeve 44 is preferably made of ceramic material. Alternatively, the aerodynamic fixed sleeve 44 includes an inner circumference that has a smooth surface made of ceramic material. The aerodynamic rotational shaft 34 is rotatably mounted in the aerodynamic fixed sleeve 44.

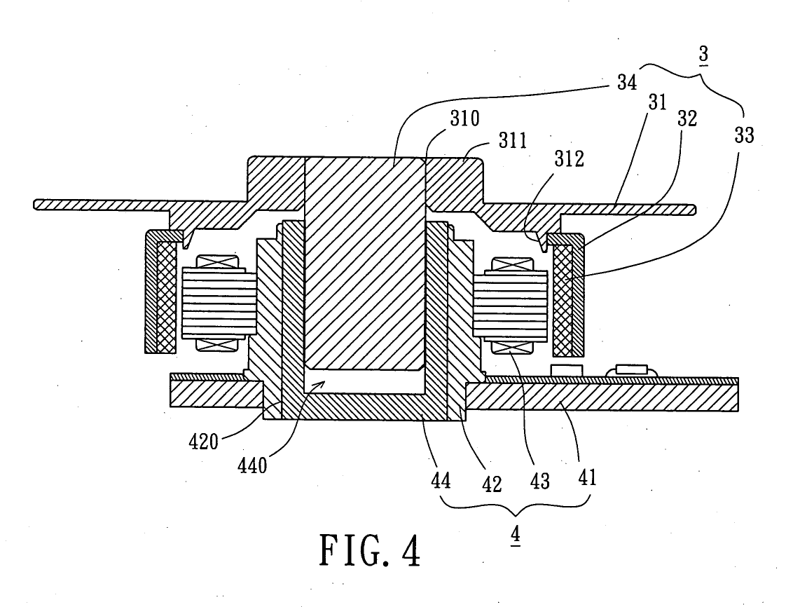

Referring to FIG. 4, in assembly, the tray 31, the rotor housing 32, the permanent magnet 33, and the aerodynamic rotational shaft 34 are firstly assembled together to form the tray assembly 3. Since only the outer circumference of an end of the aerodynamic rotational shaft 34 is engaged with the inner circumference of the engaging hole 310 of the tray 31 by forcibly fitting, the engaging area is reduced, which is advantageous to direct engagement between the aerodynamic rotational shaft 34 and the tray 31. Further, in a case that the engaging hole 310 is a through-hole, after the aerodynamic rotational shaft 34 is engaged in the engaging hole 310, the engaging relationship between the aerodynamic rotational shaft 34 and the tray 31 can still be precisely controlled and adjusted to make the rotational axis of the aerodynamic rotational shaft 34 be coincident with that of the tray 31. Thus, by assembling of the aerodynamic rotational shaft 34 in this manner, the yield of assembled products is increased, the rotational balance is improved, and the manufacturing and assembling procedures are simplified.

Further, in assembly of the fixed portion 4, the substrate 41, the axle tube 42, and the aerodynamic fixed sleeve 44 can be precisely controlled and adjusted to provide the desired engaging relationship, thereby allowing flexible adjustment. More specifically, in a case that the evenness of the outer circumference of the aerodynamic fixed sleeve 44 is not identical to that of the inner circumference of the aerodynamic hole 440, the difference can be eliminated by rapidly adjusting the engaging relationship between the substrate 41, the axle tube 42, and the aerodynamic rotational sleeve 44. Thus, coincidence of the rotational axis of the inner circumference of the aerodynamic hole 440 and the rotational axis of the aerodynamic rotational shaft 34 of the tray assembly 3 is guaranteed. Further, by mounting the aerodynamic fixed sleeve 44 in this way, the yield of assembled products is increased, the balance adjustment is more flexible, the rotational balance is improved, and the manufacturing and assembling procedures are simplified.

Still referring to FIG. 4, when assembling the tray assembly 3 and the fixed portion 4, since the outer circumference of the aerodynamic rotational shaft 34 and the inner circumference of the aerodynamic hole 440 of the aerodynamic fixed sleeve 44 are smooth surfaces made of ceramic material and since only a relatively small gap exists between the aerodynamic rotational shaft 34 and the aerodynamic fixed sleeve 44, when an end of the aerodynamic rotational shaft 34 is inserted into the blind aerodynamic hole 440 of the aerodynamic fixed sleeve 44, the air in the blind aerodynamic hole 440 is squeezed inward by the aerodynamic rotational shaft 34 and could not escape via the gap, creating an aerodynamic pressure in the aerodynamic hole 440. Thus, when the coil(s) of the stator 43 is(are) energized to create an alternating magnetic field and the permanent magnet 33 senses the alternating magnetic field and thus drives the tray assembly 3 to turn at high speed, the air in the gap avoids rotational friction between the aerodynamic rotational shaft 34 and the aerodynamic fixed sleeve 44 and thus reduces the risk of generation of frictional heat.

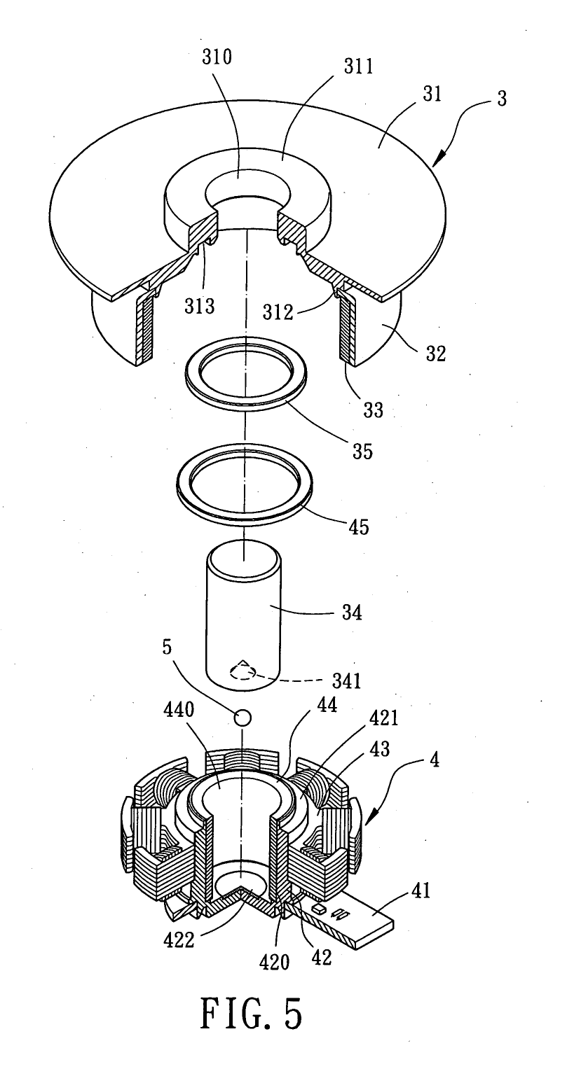

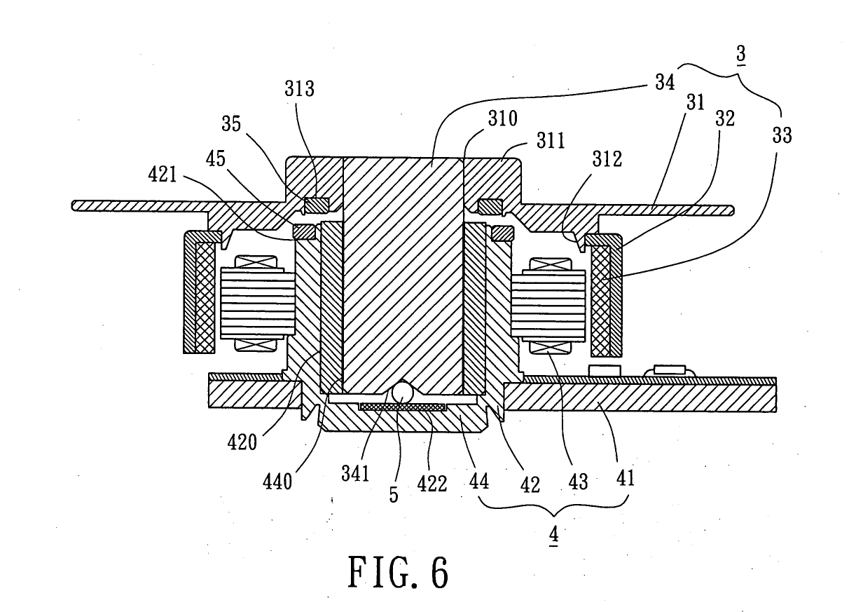

FIGS. 5 and 6 show a second embodiment of the tray assembly 3 of the present invention. In this embodiment, the tray assembly 3 further comprises a first balancing plate 35, a second balancing plate 45, and a ball 5 for assisting in rotational balance of the tray assembly 3.

More specifically, the first balancing plate 35 may be a magnetic balancing plate such as a magnetic ring, and the second balancing plate 45 may be a magnetically conductive balancing plate such as an iron ring. In an alternative example, the first balancing plate 35 may be a magnetically conductive balancing plate and the second balancing plate 45 may be a magnetic balancing plate. In another alternative example, both the first and second balancing plates 35 and 45 are magnetic balancing plates, with opposite poles respectively provided on opposed surfaces respectively of the first and second balancing plates 35 and 45.

The tray 31 includes an engaging portion 313 on the underside thereof. Preferably, the engaging portion 313 is an annular groove for receiving the first balancing plate 35. The axle tube 42 includes a shoulder 421 on a top thereof for coupling with the second balancing plate 45. After assembly, at least one portion of the surface of the first balancing plate 35 faces at least one portion of the surface of the second balancing plate 45 for mutual magnetic attraction. Thus, when the tray assembly 3 turns, the first and second balancing plates 35 and 45 assist in maintaining the relative engaging relationship between the tray assembly 3 and the fixed portion 4, preventing the tray assembly 3 from disengaging from the fixed portion 4.

Further, as illustrated in FIGS. 5 and 6, the aerodynamic rotational shaft 34 includes a recess 341 in a bottom end face thereof. The aerodynamic hole 44 is a through-hole and the receiving hole 420 of the axle tube 42 is a blind hole having an end wall (not labeled) into which a padding member 422 is mounted. In assembly, the ball 5 is mounted between a wall delimiting the recess 341 and the padding member 422. When the tray assembly 3 turns, the ball 5 assists in supporting the aerodynamic rotational shaft 34 for maintaining the engaging relationship among the aerodynamic rotational shaft 34, the aerodynamic fixed sleeve 44, and the axle tube 42 so that an appropriate gap exists among these three members for avoiding rotational friction. Alternatively, the ball 5 can be directly mounted in the recess 341, with a small portion of the ball 5 slightly protruding out of the recess 341 so that the ball 5 rotates together with the aerodynamic rotational shaft 34.

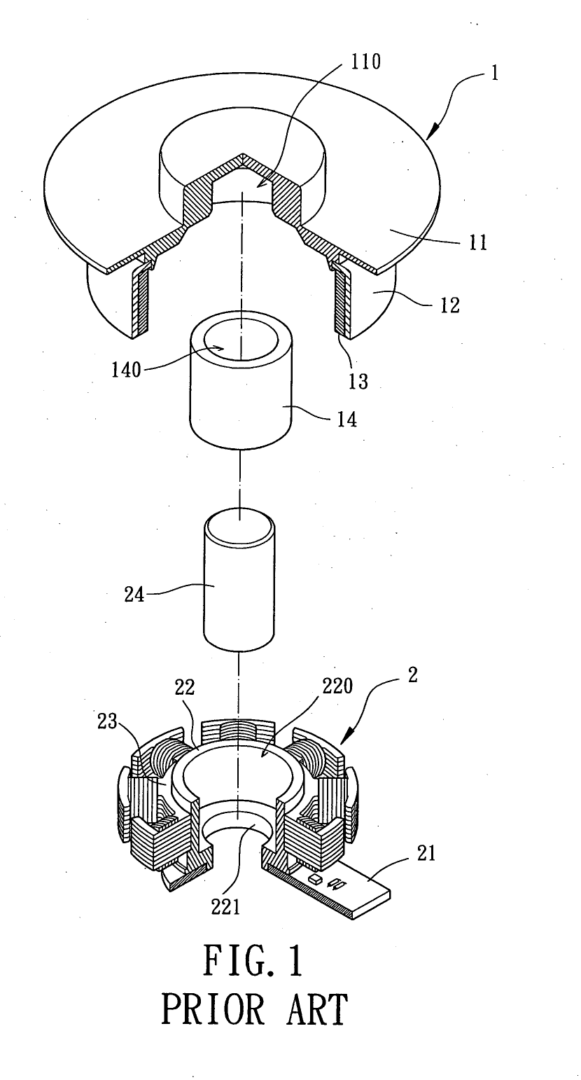

As apparent from the foregoing, in the conventional tray assembly 1 in FIG. 1, the tray 11 and the aerodynamic rotational sleeve 14 have a large engaging area and the aerodynamic rotational sleeve 14 is tubular and thus has a low structural strength such that it is inappropriate to mount the aerodynamic rotational sleeve 14 into the engaging hole 110 (in the form of a blind hole) of the tray 11 by forcibly fitting. Cracking is liable to occur, the yield of assembled products is low, the rotational balance is unsatisfactory, and miniaturization of the overall size of the spindle motor is not allowed.

By contrast, the aerodynamic rotational shaft 34 of the tray assembly 3 in accordance with the present invention can be mounted by forcibly fitting, and the aerodynamic fixed sleeve 44 is inserted into the axle tube 42. Hence, a smaller engaging force is required for coupling the aerodynamic rotational shaft 34 with the engaging hole 310 (in the form of a through-hole) of the tray 31 while allowing precise control and adjustment of the relative engaging relationship between the aerodynamic rotational shaft 34 and the aerodynamic fixed sleeve 44. Thus, the yield of assembled products is increased, the balance adjustment is flexible, the rotational balance is improved, and the manufacturing and assembling procedures are simplified. Further, the sizes of the aerodynamic rotational shaft 34 and the aerodynamic fixed sleeve 44 could be reduced, allowing miniaturization of the spindle motor.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

What is claimed is:

1. A tray assembly for a spindle motor, comprising:
a tray including an engaging hole in a center thereof, and
an aerodynamic rotational shaft including an outer circumference with a smooth surface;
the aerodynamic rotational shaft including an end engaged in the engaging hole of the tray, with the outer circumference of the end of the aerodynamic rotational shaft engaged with an inner circumference of the engaging hole of the tray by forcibly fitting, allowing precise control and adjustment of an engaging relationship between the aerodynamic rotational shaft and the tray.

2. The tray assembly for a spindle motor as claimed in claim 1, wherein the engaging hole of the tray is a through-hole to allow easy adjustment of the engaging relationship between the aerodynamic rotational shaft and the tray.

3. The tray assembly for a spindle motor as claimed in claim 1, wherein the tray further comprises a flange on an upper side thereof, with the engaging hole of the tray extending through the flange for increasing an engaging area of the inner circumference of the engaging hole.

4. The tray assembly for a spindle motor as claimed in claim 1, wherein the tray further comprises a coupling flange on an underside thereof, a rotor housing being coupled with the coupling flange, and a permanent magnet being mounted to an inner circumference of the rotor housing.

5. The tray assembly for a spindle motor as claimed in claim 1, wherein the tray assembly further comprises a fixed portion, the fixed portion comprising an aerodynamic fixed sleeve having an aerodynamic hole for rotatably receiving another end of the aerodynamic rotational shaft, with a gap existing between the aerodynamic rotational shaft and the aerodynamic fixed sleeve.

6. The tray assembly for a spindle motor as claimed in claim 5, wherein the fixed portion further comprises a substrate, an axle tube supported by the substrate, and a stator mounted around the axle tube, the aerodynamic fixed sleeve being mounted in the axle tube.

7. The tray assembly for a spindle motor as claimed in claim 5, wherein the aerodynamic hole of the aerodynamic fixed sleeve comprises an inner circumference having a smooth surface made of ceramic material.

8. The tray assembly for a spindle motor as claimed in claim 5, wherein the aerodynamic hole is a blind hole or a through-hole.

9. The tray assembly for a spindle motor as claimed in claim 6, wherein the axle tube comprises an end wall, further comprising a ball mounted between the end wall of the axle tube and an end face of the aerodynamic rotational shaft.

10. The tray assembly for a spindle motor as claimed in claim 9, wherein the end face of the aerodynamic rotational shaft comprises a recess, and wherein the ball abuts against a wall delimiting the recess.

11. The tray assembly for a spindle motor as claimed in claim 10, wherein the ball is received in the recess and slightly protrudes beyond the recess, allowing joint rotation of the ball and the aerodynamic rotational shaft.

12. The tray assembly for a spindle motor as claimed in claim 9, further comprising a padding member mounted to the end wall of the axle tube for rotatably supporting the ball.

13. The tray assembly for a spindle motor as claimed in claim 5, wherein the tray further comprises a first balancing plate and the fixed portion comprises a second balancing plate, the first balancing plate and the second balancing plate attracting each other to assist in maintaining rotational balance of the tray assembly.

14. The tray assembly for a spindle motor as claimed in claim 13, wherein the first balancing plate is one of a magnetic balancing plate and a magnetically conductive balancing plate, and wherein the second balancing plate is the other of the magnetic balancing plate and the magnetically conductive balancing plate.

15. The tray assembly for a spindle motor as claimed in claim 13, wherein the first balancing plate and the second balancing plate are magnetic balancing plates having opposed poles on opposed faces respectively of the magnetic balancing plates.

16. The tray assembly for a spindle motor as claimed in claim 13, wherein the tray further comprises an engaging portion on an underside thereof for engaging with the first balancing plate.

17. The tray assembly for a spindle motor as claimed in claim 13, wherein an axle tube of the fixed portion comprises a shoulder on a top thereof for engaging with the second balancing plate.
